(19) United States
(12) Patent Application Publication
(10) Pub. No.: US 2009/0231428 A1
(43) Pub. Date: Sep. 17, 2009

(54) Surveillance apparatus and program

(75) Inventor: Kazuyoshi Suzuki, Gunma (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/379,660

(22) Filed: Feb. 26, 2009

(30) Foreign Application Priority Data
Mar. 12, 2008 (JP) JP2008-062975

(51) Int. Cl. H04N 7/18; G06F 15/00

(52) U.S. Cl. 348/143; 702/182; 348/E07.085

(57) ABSTRACT

A surveillance apparatus capable of connecting via a communication network with a video recording device that records a video signal output from at least one surveillance camera and obtains surveillance camera trouble information pertaining to the surveillance camera detected by the video recording device. The surveillance apparatus comprises a timetable storage unit in which a timetable compiled based upon a monitoring target operating-hours schedule is stored, a trouble information judging unit that judges surveillance camera trouble information obtained during monitoring target operating hours to be valid and judges surveillance camera trouble information obtained at a time outside the monitoring target operating hours to be invalid based upon the timetable and a trouble information reporting unit that reports the surveillance camera trouble information having been judged to be valid. The structure allows the surveillance camera trouble information to be reported in an optimal manner.

### CROSS REFERENCE TO RELATED APPLICATION

The disclosure of Japanese Patent Application No. JP 2008-62975 filed Mar. 12, 2008 is incorporated herein by reference in its entirety.

### BACKGROUND OF THE INVENTION

1. Field of the Invention

The present invention relates to a surveillance apparatus and a program. More specifically, it relates to a surveillance apparatus and a program with which trouble information reporting trouble at a surveillance camera can be provided in an optimal manner.

2. Description of the Related Art

There are surveillance systems known in the related art through which a monitoring center monitors a plurality of, for instance, financial service stores through centralized surveillance by utilizing a surveillance terminal connected via a communication network with a plurality of video recording devices such as digital video recorders (DVRs) installed at the individual financial service stores.

A video recording device, connected to a surveillance camera installed to monitor a predetermined area within a staffed store or an automated facility, records a video signal output from the surveillance camera. The video recording device has a function of detecting the brightness level indicated in the video signal and sensing trouble at the surveillance camera whenever the brightness level indicated in the video signal falls below a predetermined threshold value, e.g., when the lens of the surveillance camera is covered. Upon sensing a surveillance camera trouble, the video recording device transmits trouble information that includes identification information enabling identification of the store, the video recording device and the surveillance camera to the surveillance monitoring terminal via the communication network.

Upon receiving the trouble information, the surveillance terminal checks a real-time video signal output in real time from the corresponding surveillance camera and if the brightness level in the video signal is still under the predetermined threshold value, the occurrence of a trouble is reported to the store manager in the manned store or the occurrence of trouble is reported to a neighboring store or a security company in the case of an unmanned store.

The video recording device, which senses a surveillance camera trouble whenever the brightness level indicated in the video signal falls below a predetermined threshold value, senses surveillance camera trouble and transmits trouble information to the surveillance terminal even when the lights at the store are turned off during, for instance, closing hours. This issue is addressed by equipping the video recording device with a function of sensing surveillance camera troubles in conformance with a timetable stored therein, which is set based upon an operating-hours schedule indicating the hours of operation for each day of the week at the store where the video recording device is installed. The video recording device equipped with this function does not transmit trouble information to the surveillance terminal when the lights are off during, for instance, closing hours.

### SUMMARY OF THE INVENTION

However, when the store operates on an irregular schedule, e.g., on national holidays, during the year-end holidays or during store maintenance or the like, the timetable stored in the video recording device will not match the operating schedule and the video recording device will send trouble information to the surveillance terminal in the surveillance system in the related art. Under such circumstances, the operator at the monitoring center needs to check the store operating-hours schedule to see whether or not the store is operating on an irregular schedule and judge whether or not each instance of trouble information is valid. There are problems inherent to this method, however, in that when a great number of stores are surveilled through centralized monitoring, the length of time required to check the store operating-hours schedule and determine the validity of each instance of trouble information will take too long and the operator may become prone to making errors of judgment.

While a timetable compiled by reflecting the business hours during holidays may be stored in each video recording device, the operating-hours schedules vary from store to store and thus, the timetable setting process will be a laborious, time-consuming task. In addition, the timetable will have to be updated every year. When the store is to operate on an irregular schedule due to, for instance, store maintenance, the timetable may not be adjusted in time and, in such a case, the operator of the monitoring center will have to check the operating-hours schedule and make a judgment with regard to the validity of any trouble information.

An object of the present invention having been completed by addressing the issues discussed above, is to provide a surveillance apparatus and a program, with which trouble information reporting trouble of a surveillance camera can be provided in an optimal manner.

The object described above is achieved in a first aspect of the present invention by providing a surveillance apparatus that is capable of connecting via a communication network with a video recording device that records a video signal output from at least one surveillance camera, and obtains surveillance camera trouble information pertaining to the surveillance camera detected by the video recording device. The surveillance apparatus comprises a timetable storage unit in which a timetable compiled based upon a monitoring target operating-hours schedule is stored, a trouble information judging unit that judges surveillance camera trouble information obtained during monitoring target operating hours to be valid and judges surveillance camera trouble information obtained at a time outside the monitoring target operating hours to be invalid based upon the timetable and trouble information reporting unit that reports the surveillance camera trouble information having been judged to be valid.

The structure described above allows the surveillance apparatus to judge the validity of the surveillance camera trouble information based upon the timetable compiled in accordance with the monitoring target operating-hours schedule and report only the trouble information judged to be valid. As a result, the surveillance camera trouble information can be reported in an optimal manner. Since the operator of the surveillance system is not required to check and judge the validity of the trouble information, no time needs to be allocated for checking and judging the validity of the trouble information and the risk of erroneous judgment is eliminated. In addition, it is no longer necessary to set a timetable based upon the operating-hours schedule at each video recording device.

The surveillance apparatus may further comprise a timetable updating unit that updates the timetable. Since the timetable stored in the surveillance apparatus can be updated by the timetable updating unit whenever necessary, the need to update the timetable at each video recording device is eliminated.

The object described above is further achieved in a second aspect of the present invention by providing a program enabling the surveillance apparatus in the first aspect described above to execute monitoring processing.

The object described above is also achieved in a third aspect of the present invention by providing a surveillance apparatus that is capable of connecting via a communication network with a video recording device which records video signals provided from a plurality of surveillance cameras and obtains surveillance camera trouble information detected by the video recording device. The surveillance apparatus comprises a trouble information judging unit that, after obtaining surveillance camera trouble information pertaining to a specific surveillance camera, judges the surveillance camera trouble information pertaining to the specific surveillance camera to be valid if trouble information pertaining to all the surveillance cameras connected to the video recording device is not obtained within a predetermined length of time and judges the surveillance camera trouble information pertaining to the specific surveillance camera to be invalid if trouble information pertaining to all the surveillance cameras is obtained within the predetermined length of time, and a trouble information reporting unit that reports the surveillance camera trouble information pertaining to the specific surveillance camera having been judged to be valid.

After obtaining trouble information pertaining to a specific surveillance camera, the surveillance apparatus adopting the structure described above judges the validity of the trouble information based upon whether or not trouble information pertaining to all the surveillance cameras is obtained within the predetermined length of time and reports the trouble information only if it is judged to be valid. As a result, surveillance camera trouble information can be reported in an optimal manner. Since the need to set and update a timetable compiled based upon the monitoring target operating-hours schedule is eliminated, there is no longer any risk of setting or updating the timetable erroneously.

The object described above is further achieved in a fourth aspect of the present invention by providing a program enabling the surveillance apparatus in the third aspect described above to execute monitoring processing.

According to the present invention, a surveillance apparatus and a program, which allow surveillance camera trouble information to be reported in an optimal manner, are provided.

### BRIEF DESCRIPTION OF THE DRAWINGS

FIG. 1 shows the configuration of the surveillance system achieved in a first embodiment;

FIG. 2 shows the structure adopted in the surveillance apparatus in the first embodiment;

FIG. 3 shows a timetable stored in the surveillance apparatus in the first embodiment;

FIG. 4 shows the structure adopted in the surveillance apparatus achieves in a second embodiment;

FIG. 5 shows a check table stored in the surveillance apparatus in the second embodiment;

FIG. 6 presents a flowchart of the operation executed in the surveillance apparatus in the second embodiment;

FIG. 7 shows the configuration of a surveillance system in the related art;

FIG. 8 shows timetables stored in DVRs in the surveillance system in the related art; and

FIG. 9 shows a timetable stored in a DVR in the surveillance system in the related art.

### DETAILED DESCRIPTION OF THE PREFERRED EMBODIMENTS

Hereafter, preferred embodiments of the present invention will be described in detail with reference to the appended drawings. Note that, in the specification and the appended drawings, structural elements that have substantially identical functions and structures are denoted with the same reference numerals and that a repeated explanation of these structural elements is omitted.

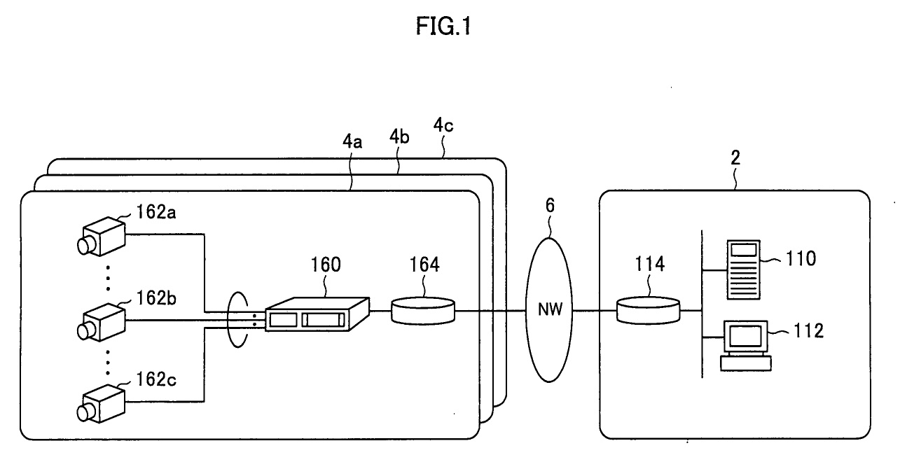

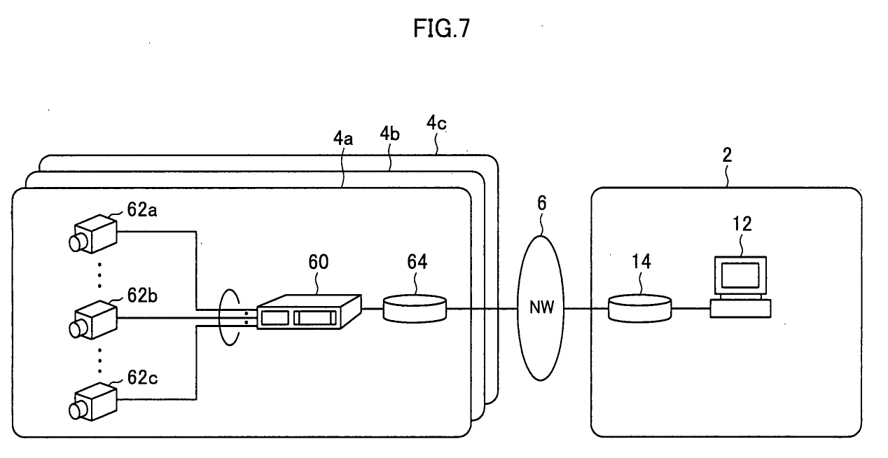

A surveillance system in the related art is first described in reference to FIGS. 7 through 9, before the surveillance systems achieved in the embodiments of the present invention are described in reference to FIGS. 1 through 6.

FIG. 7 shows the configuration of a surveillance system in the related art. The surveillance system in FIG. 7 includes DVRs 60 and surveillance cameras 62a˜62c (hereafter collectively referred to as surveillance cameras 62) installed in a plurality of stores 4a˜4c (hereafter collectively referred to as stores 4) and a surveillance terminal 12 installed at a monitoring center 2. The DVRs 60 are each connected to the surveillance terminal 12 through a router 64 at the corresponding store 4, a communication network 6 and a router 14 at the monitoring center 2.

The surveillance cameras 62 are each installed at a specific location within the store 4, e.g., a service counter or an ATM area. The surveillance camera 62 captures a video image of the monitoring target area and outputs a video signal of the captured image to the DVR 60.

The DVR 60 is connected to at least one surveillance camera 62 and records the video signal output from the surveillance camera 62. The DVR 60 has a function of detecting, for instance, the brightness level in the video signal and sensing trouble at the surveillance camera 62 if the brightness level in the video signal is less than a predetermined threshold value. Upon sensing trouble at the surveillance camera 62, the DVR 60 transmits trouble information including identification information indicating the store number, the DVR number and the camera number to the surveillance terminal 12.

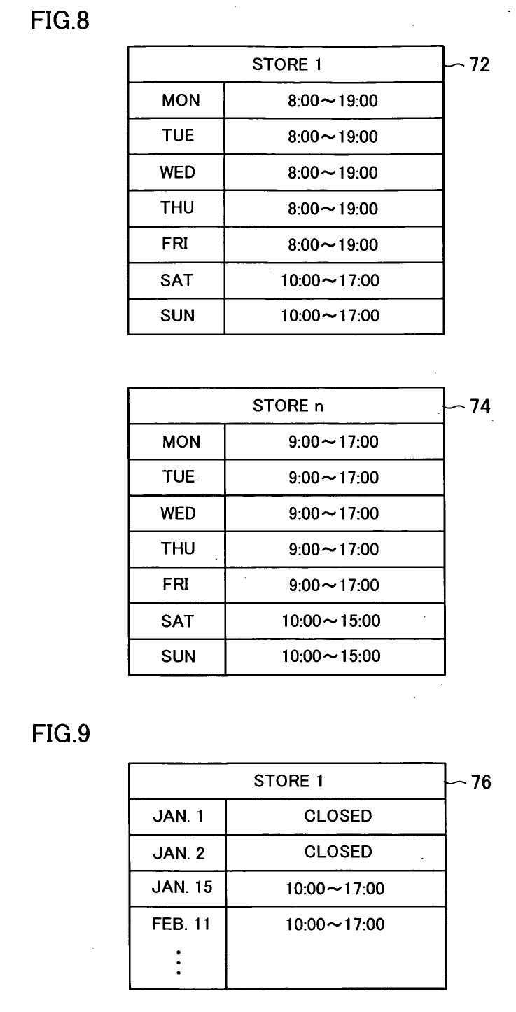

Timetables such as the timetables 72, 74 and 76 shown in FIGS. 8 and 9 are stored in the DVRs 60. As FIGS. 8 and 9 indicate, the timetables 72, 74 and 76 each include information related to the operating-hours schedule for regular business days, non-business days, national holidays and the like at a given store 4. The DVRs 60 each record the monitoring target video signal in accordance with the timetables 72, 74 or 76 and detects trouble occurring at the surveillance camera 62.

FIG. 8 shows timetables 72 and 74 indicating the operating hours of store 1 and store n on regular business days and non-business days. FIG. 8 shows that operating hours for store 1 are 8:00˜19:00 on weekdays and 10:00˜17:00 on weekends. Operating hours for store n are 9:00˜17:00 on weekdays and from 10:00˜15:00 on non-business days.

FIG. 9 shows a timetable 76 indicating the holiday operating hours at store 1. As FIG. 9 indicates, store 1 is closed on January 1 and January 2 and is open from 10:00 to 17:00 on January 15 and February 11.

The DVRs 60 detect trouble at the surveillance cameras 62 in accordance with timetables, e.g., the timetables 72, 74 and 76 described above. In other words, they detect trouble at the surveillance cameras in accordance with the corresponding store operating-hours schedules. This means that they do not detect any trouble beyond the operating hours of the stores 4. Namely, when the lights are turned off at the end of business at the stores 4, the DVRs 60 do not sense trouble and thus no trouble information is transmitted to the surveillance terminal 12.

However, since the individual stores 4 are open on different operating-hours schedules, as explained earlier, the procedure through which the timetables 72, 74 and 76 are set is bound to be a laborious task and the holiday timetable 76 in particular, must be updated every year. In addition, in the event of an emergency such as store closings for repairs, the timetable 72, 74 or 76 may not be reset in time.

### First Embodiment

FIG. 1 shows the configuration of the surveillance system achieved in the first embodiment of the present invention. In the description of the surveillance system achieved in the first embodiment, structural elements similar to those in the surveillance system in the related art are not explained.

As shown in FIG. 1, the surveillance system includes DVRs (video recording devices) 160 and surveillance cameras 162a, 162b and 162c (hereafter collectively referred to as surveillance cameras 162), installed at a plurality of stores 4a, 4b and 4c (hereafter collectively referred to as stores 4), and a surveillance server 110 and a surveillance terminal 112 installed at a monitoring center 2. The DVRs 160 are each connected to the surveillance server 110 and the surveillance terminal 112 through a router 164 at the corresponding store 4, a communication network 6 and a router 114 at the monitoring center 2. It is to be noted that a single DVR 160 may be installed at each store 4 or a plurality of DVRs 160 may be installed at a store 4.

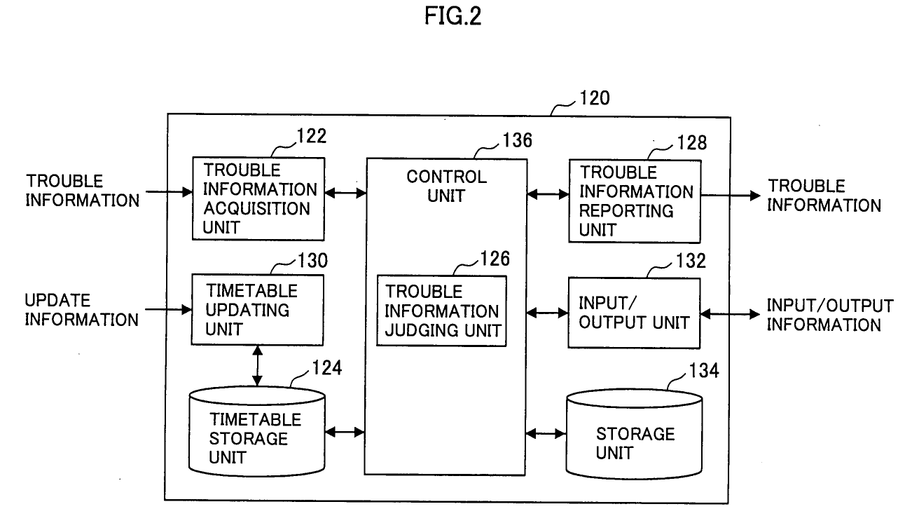

FIG. 2 shows the structure adopted in the surveillance apparatus in the first embodiment. A surveillance apparatus 120 achieved in the embodiment is constituted with a surveillance server 110 and a surveillance terminal 112. As shown in FIG. 2, the surveillance apparatus 120 includes a trouble information acquisition unit 122, a timetable storage unit 124, a trouble information judging unit 126, a trouble information reporting unit 128, a timetable updating unit 130, an input/output unit 132, a storage unit 134 and a control unit 136.

The trouble information acquisition unit 122 obtains from a DVR 160 trouble information pertaining to a surveillance camera 162 detected via the DVR 160. Timetables 142 and 144, set based upon the operating-hours schedules for monitoring target stores 4, are stored in the timetable storage unit 124, as detailed later. The trouble information judging unit 126 judges the validity of trouble information having been obtained based upon the timetables 142 and 144. The trouble information reporting unit 128 reports trouble information judged to be valid. The timetable updating unit 130 updates the timetables 142 and 144 stored in the timetable storage unit 124.

The input/output unit 132 is a user interface such as a keyboard or a monitor. In the storage unit 134, various types of information needed when engaging the surveillance apparatus 120 in operation and the like are stored. The control unit 136 controls the overall operation of the surveillance apparatus 120 by controlling the other structural elements described above.

Among the structural elements of the surveillance apparatus 120, the trouble information acquisition unit 120, the trouble information judging unit 126, the trouble information reporting unit 128 and the timetable updating unit 130 may be configured by installing software programs that fulfill the functions of the individual structural elements into the storage unit 134 or they may be configured as dedicated hardware units. In addition, the timetable storage unit 124 and the storage unit 134 may be constituted with any of various types of storage media including semiconductor memory, optical disks and magnetic disks.

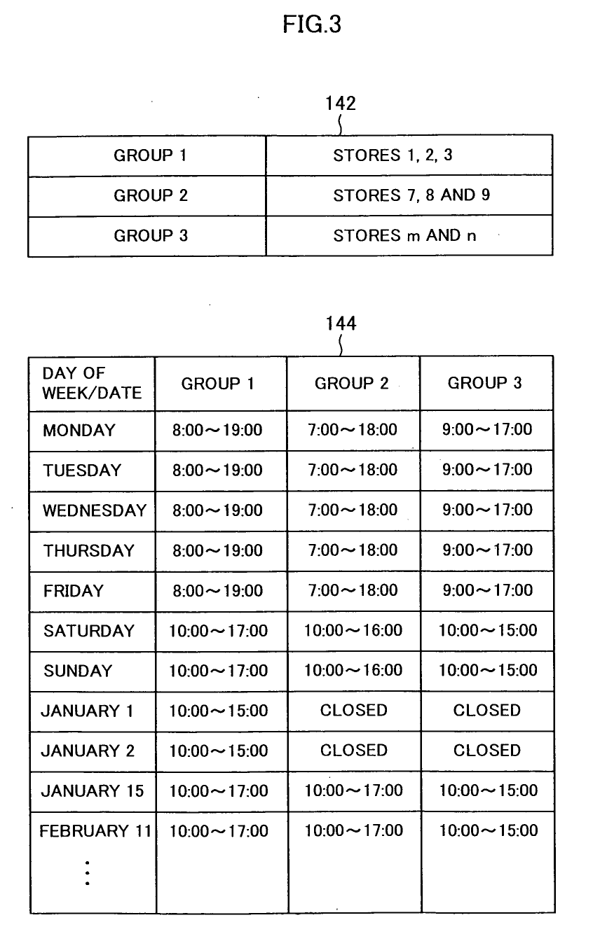

In the surveillance system, the timetables 142 and 144 shown in FIG. 3 are stored in the surveillance server 110 instead of in DVRs 160. While the timetables 142 and 144 are stored in the timetable storage unit 124 in the embodiment, the timetables 142 and 144 may instead be stored in an external storage device connected to the surveillance server 110 or in the storage unit 134. In addition, the timetables 142 and 144 can be updated as necessary via the timetable updating unit 130.

As shown in FIG. 3, the timetables 142 and 144 consist of a first table 142 and a second table 144. The first table 142 contains grouping information that divides stores 4 into groups each sharing a common operating-hours schedule. The second table 144 contains information indicating the common operating-hours schedule shared among the stores 4 belonging to each group. It is to be noted that following explanation is given by assuming that the operating-hours schedules for the stores 4 themselves are directly set in the second table 144.

FIG. 3 shows a first table 142 grouping stores 1˜3 as group 1, grouping stores 7˜9 as group 2 and grouping stores m and n as group 3 and a second table 144 containing information indicating a common operating-hours schedule shared by the individual stores belonging to each of groups 1, 2 and 3.

FIG. 3 indicates that stores 1˜3 in group 1 are open from 10:00 to 15:00 on January 1 and January 2 and are open from 10:00 to 17:00 on January 15 and February 11.

The operating method adopted in the surveillance system is now described.

Upon detecting trouble at a surveillance camera 162, a DVR 160 installed in a store transmits trouble information indicating the store number, the DVR number and the camera number to the monitoring center 2. At the monitoring center 2, the surveillance server 110 having received the trouble information judges the validity of the trouble information, the trouble information is output to the surveillance terminal 112 as necessary and the surveillance terminal 112 reports the trouble information.

The control unit 136, having obtained the trouble information via the trouble information acquisition unit 122, references the timetables 142 and 144 stored in the timetable storage unit 124. Then, based upon the store number included in the trouble information and the first table 142, the control unit 136 identifies the group to which the particular store belongs. The control unit 136 next determines a specific timetable corresponding to the operating-hours schedule of the store based upon the identified group and the second table 144.

The control unit 136 engages the trouble information judging unit 126 to make a decision as to whether or not the trouble information was received during the store operating hours based upon the determined timetable and information provided from a system clock. At this time, if the trouble information is determined to have been received during the store operating hours, the trouble information judging unit 126 judges that trouble has occurred at the surveillance camera 162 (the trouble information is valid) and outputs the trouble information to the trouble information reporting unit 128. If, on the other hand, the trouble information is determined to have been received outside the store operating hours, the trouble information judging unit 126 judges that no trouble has occurred at the surveillance camera 162 (the trouble information is invalid) and does not output the trouble information to the trouble information reporting unit 128. The surveillance server 110 may discard trouble information having been judged to be invalid or it may record invalid trouble information in a reception log together with trouble information judged to be valid.

For instance, if trouble information is received at 10:00 on January 1 from store 1 belonging to group 1, the trouble information judging unit 126 determines that the trouble information has been received during the operating hours of store 1 based upon the timetables 142 and 144, thus judges that the trouble information is valid and outputs the trouble information to the trouble information reporting unit 128. However, if trouble information is received at 10:00 on January 1 from store 7 belonging to group 2, the trouble information judging unit 126 determines that the trouble information has been received outside the operating hours of store 7 based upon the timetables 142 and 144, thus judges that the trouble information is invalid and does not output the trouble information to the trouble information reporting unit 128.

Upon obtaining valid trouble information, the surveillance apparatus 120 reports the occurrence of trouble to the store, a security company or the like, as in the related art, via the trouble information reporting unit 128 at the surveillance terminal 112. The occurrence of trouble may be automatically reported from the surveillance terminal 112 or it may be reported via the operator of the surveillance terminal 112.

In the surveillance system achieved in the embodiment described above, the surveillance apparatus 120 judges the validity of the trouble information pertaining to a surveillance camera 162 in accordance with the timetables compiled based upon the monitoring target operating-hours schedules and reports the occurrence of trouble only if the trouble information is judged to be valid. As a result, trouble information pertaining to surveillance cameras 162 can be reported in an optimal manner. Since this eliminates the need for the operator to check and determine the validity of trouble information, no time is required for checking and judging the validity of the trouble information and the risk of erroneous judgment is eliminated.

Furthermore, since the timetables 142 and 144 are stored in the surveillance apparatus 120 and the timetables 142 and 144 are updated as needed, the need to set and update the individual timetables 72, 74 and 76 at various DVRs 160 is eliminated.

### Second Embodiment

In the description of the surveillance system achieved in the second embodiment, structural elements similar to those in the surveillance system in the first embodiment are not explained.

The surveillance system includes a surveillance server 210 and a surveillance terminal 212 installed at the monitoring center 2. The surveillance system assumes a configuration similar to that of the surveillance system shown in FIG. 1. It is to be noted that while a single DVR 160 may be installed at each store 4 or a plurality of DVRs 160 may be installed at a given store, the following description is given by assuming that a single DVR unit is installed in each store 4.

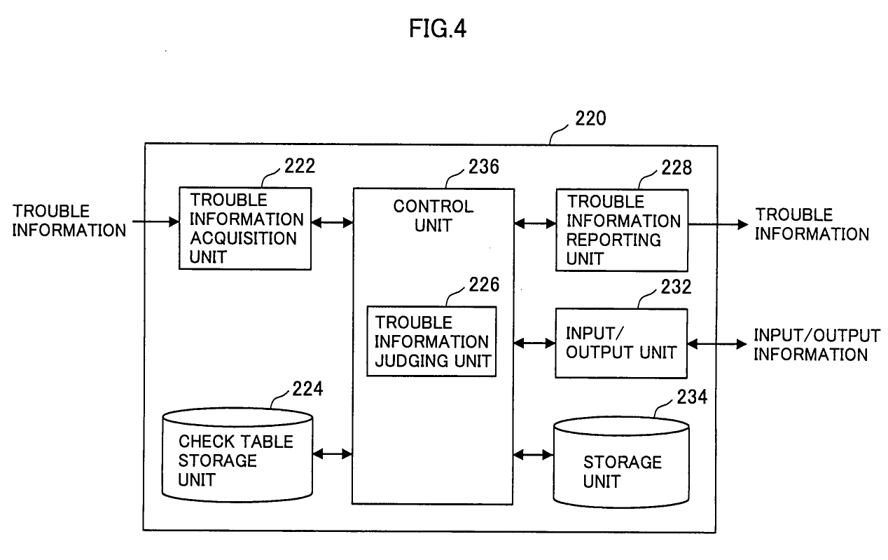

FIG. 4 shows the structure adopted in the surveillance apparatus achieved in the second embodiment. The surveillance apparatus 220 includes a trouble information acquisition unit 222, a check table storage unit 224, a trouble information judging unit 226, a trouble information reporting unit 228, an input/output unit 232, a storage unit 234 and a control unit 236, as shown in FIG. 4.

The trouble information acquisition unit 222, the trouble information reporting unit 228, the input/output unit 232, the storage unit 234 and the control unit 236 assume structures and functions similar to those of the corresponding units in the surveillance apparatus 120 in the first embodiment. In the check table storage unit 224, a check table 244 utilized when judging the validity of trouble information is stored. The trouble information judging unit 226 judges the validity of trouble information based upon the conditions under which trouble information is obtained within a predetermined time frame from surveillance cameras 162 connected to a specific DVR 160.

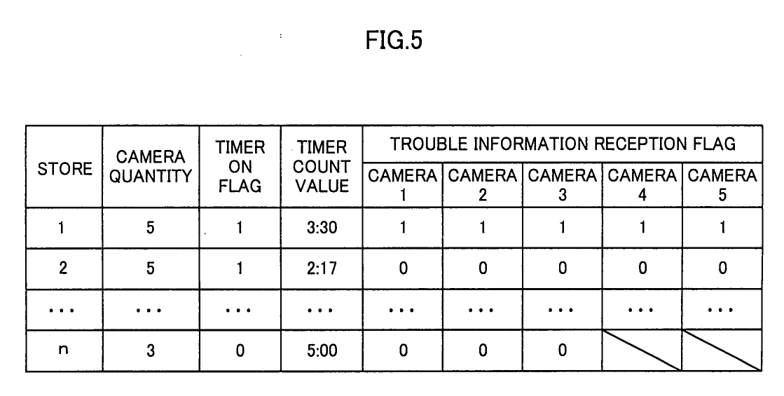

The surveillance server 210 in the surveillance system utilizes the check table 242, without storing the timetables 142 and 144. While the check table 242 is stored in the check table storage unit 224 in the embodiment, the check table 242 may be stored in an external storage device connected to the surveillance server 210 or in the storage unit 234. As shown in FIG. 5, the check table 242 contains information used by the surveillance server 210 to detect trouble at the surveillance cameras 162.

The check table 242 is made up with information indicating camera quantities, timer ON flags, information indicating timer count values and trouble information reception flags. The camera quantity information indicates the quantity of surveillance cameras 162 connected to the DVR 160 at each store 4. A timer ON flag is flag information indicating the ON/OFF state of the timer corresponding to each DVR 160. The timer count value information indicates the count value provided via each timer. A trouble information reception flag is flag information indicating whether or not trouble information pertaining to the surveillance cameras 162 connected to each DVR 160 has been received.

The timer ON flag may be set to, for instance, “1” while the timer is on and set to “0” when the timer is not on. The timer may start a count at an initial count value of, for instance, “5:00” and end the count at “0:00”. The trouble information reception flag may be set to “1” upon receiving trouble information and may assume the value of “0” otherwise.

FIG. 5 indicates that the DVR 160 installed at store 1 is connected with five surveillance cameras 162. The timer corresponding to the DVR 160 is on, indicating a count value of “3:30”. Trouble information pertaining to the surveillance cameras 1˜5 has been received at the surveillance server 210.

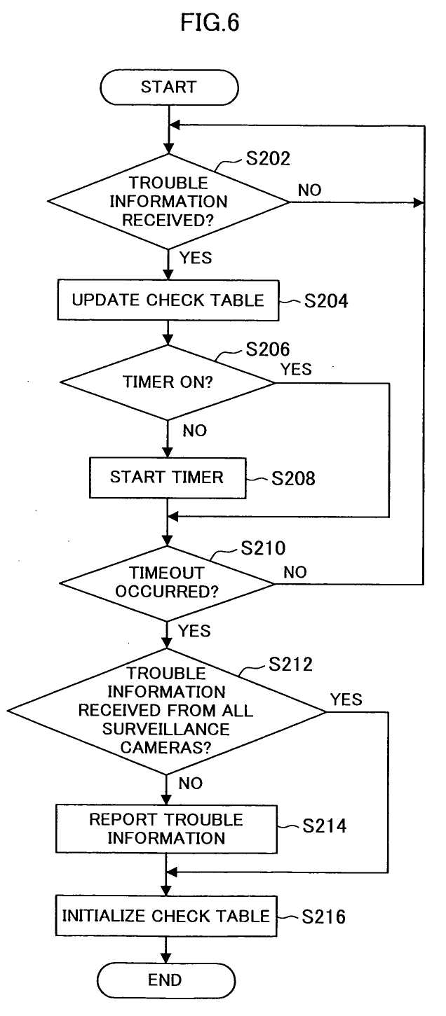

FIG. 6 presents a flowchart of the operation executed at the surveillance apparatus. The operation method adopted in the surveillance apparatus 220 is explained below in reference to FIG. 6.

The control unit 236 makes a decision as to whether or not trouble information has been received and if it is decided that trouble information has been received, the operation shifts into the processing in step S204, whereas reception of trouble information is continuously monitored (S202) if trouble information has not yet been received.

Upon receiving trouble information via the trouble information acquisition unit 222, the control unit 236 updates the check table 242 stored in the check table storage unit 224 based upon the store number and the camera number indicated in the trouble information (S204). Namely, the trouble information flag corresponding to the specific camera in the particular store is set to “1”. It is to be noted that if a plurality of DVRs 160 are installed at the store, the trouble information may also indicate the DVR number and the control unit 236 may check this DVR number as well.

The control unit 236 makes a decision as to whether or not the timer is on by checking the timer ON flag corresponding to the store (S206). If the timer is not currently in the on state, the control unit 236 sets the timer ON flag to “1” and thus starts up the timer (S208). Once the timer is confirmed to be on or is turned on, the control unit 236 shifts into the processing in S210.

The control unit 236 checks the timer count value corresponding to the store and makes a decision as to whether or not a timeout has occurred (S210). If a timeout has occurred at the timer for the particular store, the control unit 236 shifts into the processing in S212, whereas if a timeout has not occurred, the control unit returns to the processing in S202. Namely, the control unit 236 makes a decision as to whether or not trouble information has also been received from another surveillance camera 162 installed in the store.

If it is decided that a timeout has occurred, the control unit 236 engages the trouble information judging unit 226 to check the trouble information reception flags for all the surveillance cameras 162 (e.g., the surveillance cameras 162a˜162c at store 4a in FIG. 1) installed in the store to make a decision as to whether or not trouble information pertaining to all the surveillance cameras 162 has been received (S212). If it is decided that trouble information pertaining to all the surveillance cameras 162 has been received, the control unit 236 shifts into the processing in S216, whereas it outputs the trouble information to the trouble information reporting unit 228 (S214) if trouble information pertaining to all the surveillance cameras has not been received.

After deciding whether or not trouble information pertaining to all the surveillance cameras 162 has been received, the control unit 236 initializes the timer ON flag, the timer count value and the trouble information reception flags corresponding to the particular store (S216).

If trouble information pertaining to at least one of all the surveillance cameras 162 installed in the store 4 has not been received within the predetermined time frame set on the timer, the trouble information judging unit 226 judges that trouble has occurred at the surveillance camera 162 (the trouble information is valid) and outputs the trouble information to the trouble information reporting unit 228. If, on the other hand, trouble information pertaining to all the surveillance cameras 162 installed in the store 4 is received during the predetermined time frame set at the timer, the trouble information judging unit 226 judges that no trouble has occurred at the surveillance camera 162 (the trouble information is invalid) and does not output the trouble information to the trouble information reporting unit 228.

In other words, when the lights are turned off after the operating hours at the store 4, the DVR 160 detects trouble at all the surveillance cameras 162 installed in the store 4 and transmits the trouble information pertaining to all the surveillance cameras 162 to the surveillance server 210 during the predetermined time frame. As a result, the surveillance server 210 receives the trouble information pertaining to all the surveillance cameras 162 installed in the store 4 during the predetermined time frame from the DVR 160.

Thus, by setting the timer so as to count the predetermined length of time set for each store 4 and making a decision as to whether or not trouble information pertaining to all the surveillance cameras 162 in the store 4 has been received before the timeout, any trouble occurring at a surveillance camera 162 can be accurately detected. It is to be noted that different values may be set as the timer count initial value for various stores 4 based upon varying conditions applicable to the individual stores 4.

As described above, after obtaining trouble information pertaining to a specific surveillance camera 162, the surveillance apparatus 220 in the surveillance system achieved in the embodiment judges the validity of the trouble information based upon whether or not trouble information pertaining to all the surveillance cameras 162 has been obtained during the predetermined time frame and outputs the trouble information only if it is judged to be valid. As a result, the trouble information pertaining to the surveillance camera 162 can be reported in an optimal manner. Since the need to set and update the monitoring target operating schedules is eliminated, there is no longer any risk of setting or updating the schedules erroneously.

Although preferred embodiments of the present invention have been described in reference to the drawings, the present invention is not limited thereto. It should be understood by those skilled in the art that various modifications, combinations, some combinations and alterations may be made depending upon design requirements and other factors insofar as they are within the scope of the appended claims or equivalents thereof.

For instance, the surveillance apparatuses 120 and 220 achieved in the embodiments are respectively constituted with the surveillance servers 110 and 220 and the surveillance terminals 112 and 222. However, the present invention may be adopted equally effectively in a surveillance apparatus 120 or 220 achieved as an integrated unit fulfilling the functions of both the surveillance server 110 or 220 and the surveillance terminal 112 or 222.

What is claimed is;

1. A surveillance apparatus that is capable of connecting via a communication network with a video recording device that records a video signal output from at least one surveillance camera and obtains surveillance camera trouble information pertaining to said surveillance camera detected by said video recording device, comprising:
a timetable storage unit in which a timetable compiled based upon a monitoring target operating-hours schedule is stored;
a trouble information judging unit that judges said surveillance camera trouble information obtained during monitoring target operating hours to be valid and judges said surveillance camera trouble information obtained at a time outside the monitoring target operating hours to be invalid based upon said timetable; and
a trouble information reporting unit that reports said surveillance camera trouble information having been judged to be valid.

2. A surveillance apparatus according to claim 1, further comprising:
a timetable updating unit that updates said timetable.

3. A program enabling a surveillance apparatus to execute a surveillance method in a surveillance system that includes a video recording device that records a video signal provided from at least one surveillance camera and said surveillance apparatus that obtains through a communication network surveillance camera trouble information pertaining to said surveillance camera detected by said video recording device, wherein:
said surveillance method comprises;
a trouble information judging step in which said surveillance camera trouble information obtained during operating hours of a monitoring target is judged to be valid and said surveillance camera trouble information obtained outside the operating hours of said monitoring target is judged to be invalid based upon a timetable compiled in accordance with an operating-hours schedule of said monitoring target; and
a trouble information reporting step in which said surveillance camera trouble information said having been judged to be valid is reported.

4. A surveillance apparatus that is capable of connecting via a communication network with a video recording device which records video signals provided from a plurality of surveillance cameras and obtains surveillance camera trouble information detected by the video recording device, comprising:
a trouble information judging unit that, after obtaining surveillance camera trouble information pertaining to a specific surveillance camera, judges said surveillance camera trouble information pertaining to said specific surveillance camera to be valid if trouble information pertaining to at least one of all surveillance cameras connected to said video recording device is not obtained within a predetermined length of time and judges said surveillance camera trouble information pertaining to said specific surveillance camera to be invalid if trouble information pertaining to all the surveillance cameras is obtained within the predetermined length of time; and
a trouble information reporting unit that reports said surveillance camera trouble information pertaining to said specific surveillance camera having been judged to be valid.

5. A program enabling a surveillance apparatus to execute a surveillance method in a surveillance system that includes a video recording device that records video signals provided from a plurality of surveillance cameras and said surveillance apparatus that obtains through a communication network surveillance camera trouble information detected by said video recording device, wherein:
said surveillance method comprises;
a trouble information judging step in which, upon obtaining surveillance camera trouble information pertaining to a specific surveillance camera, said surveillance camera trouble information pertaining to said specific surveillance camera is judged to be valid if trouble information pertaining to at least one of all surveillance cameras connected to said video recording device is not received within a predetermined length of time and said surveillance camera trouble information pertaining to said specific surveillance camera is judged to be invalid if surveillance camera trouble information pertaining to all the surveillance cameras is received within the predetermined length of time; and
a trouble information reporting step in which said surveillance camera trouble information pertaining to said specific surveillance camera having been judged to be valid is reported.
